(19) United States
(12) Patent Application Publication
(10) Pub. No.: US 2006/0058955 A1
(43) Pub. Date: Mar. 16, 2006

(54) Device for a motor vehicle, for the avoidance of an unintentional depletion of fuel reserves of the motor vehicle

(76) Inventor: Dirk Mehren, Sindelfingen (DE)

Correspondence Address: PENDORF & CUTLIFF, 5111 MEMORIAL HIGHWAY, TAMPA, FL, 33634-7356, US

(21) Appl. No.: 11/091,209

(22) Filed: Mar. 28, 2005

(30) Foreign Application Priority Data
Mar. 26, 2004 (DE) 10 2004 015 389.2

(51) Int. Cl. G01C 21/34

(52) U.S. Cl. 701/209; 340/995.19

(57) ABSTRACT

The invention concerns a device (1) for a motor vehicle, for avoiding an unintended complete depletion of the fuel reserves of the motor vehicle. The device is provided with a sensor (2) for determining the amount of fuel remaining in the vehicle. Further, it includes a navigation device (4), which is activated upon dropping below a minimum fuel amount and which automatically determines the actual position of the vehicle. From the position of the vehicle, the actual direction of driving and/or the road upon which the vehicle is actually located is determined. On the basis of this information, a gas station is identified in the direction or along the path of the ascertained road, and a route guidance is activated with this identified gas station as goal, and the vehicle operator is provided with appropriate driving instructions. By this procedure, it is possible to substantially prevent an unintended complete consumption of the fuel reserve even in the case that the navigation device is not initially activated.

### BACKGROUND OF THE INVENTION

1. Field of the invention

The invention concerns a device for a motor vehicle, for avoiding an unintentional depletion of fuel reserves of the motor vehicle.

2. Related Art of the Invention

It is known to activate, when a motor vehicle drops below a minimum fuel amount, a fuel reserve indicator which is typically in the form of a colored light or a pictogram, for example, in the shape of a gas pump. This fuel reserve display is generally provided in the vicinity of the fuel gauge. With this fuel reserve display, a motor vehicle operator is provided with information that the fuel reserve has fallen below a predetermined minimum. The fuel reserve display provides the motor vehicle operator an indication that he should start looking for a gas station for filling the gas tank.

From European Patent Application EP 1 130 560 A2, a device and a process for operating a motor vehicle are known, in which a sensor is used to determine the amount of fuel remaining and wherein, in the case that a navigation device is activated, that is, a navigation device is guiding the vehicle operator from a starting position to a predetermined target position using active route guidance, it determines a route of travel to a gas station and provides appropriate driving directions in the case of falling below the minimum fuel reserve.

### SUMMARY OF THE INVENTION

The present invention is concerned with the task of further improving a device according to the state of the art in such a manner that it reliably prevents a complete exhaustion of the fuel reserves of a motor vehicle.

This task is inventively solved by a device for a motor vehicle with the characterizing features of patent claim 1.

Advantageous further developments are set forth in the dependent claims.

The inventive device includes a navigation device which is so designed and controlled that when the fuel reserve falls below a minimum fuel amount, that in the case that the route guidance system is not activated, in a first step it determines the position of the vehicle. This typically occurs using GPS-data or map data or also using other information sources, for example, by vehicle sensors or by other vehicle components which make possible a determination of location, for example, by radio communication. On the basis of the position, or as the case may be, the determined position of the vehicle, next the actual direction of travel and/or the road is determined, upon which the vehicle is actually located. Therein, alternatively or supplementally, the actual direction of travel, as well as the actual road, can be determined. On the basis of this actual direction of travel and/or the actual road, next the gas station is determined which lies in the direction of travel and/or in the path of the ascertained road. Therein, the direction and/or the path of the ascertained road is derived on the basis of the actual direction of travel as determined from the vehicle position and/or from the actual road. Therein, the direction can correspond to the actual direction of driving or also lie in an area about the actual driving direction. In corresponding manner, the path of the determined road can correspond to the true path of the actual road; however, could also correspond to an extension of the path of the actual road, or also could lie in a corridor bracketing the actual road, or bracketing the extension of the actual road.

The determination of the gas station, or as the case may be, the determination of the direction or the path of the road, is preferably accomplished using map data. After the gas station has been found in the direction and/or the path of the ascertained road, a route guidance or driving direction of the now activated navigation device is started, wherein the selected gas station is used as the target and the ascertained position of the motor vehicle is selected as the starting point.

According to this inventive device for a motor vehicle, it is now ensured that in the case that the route guidance of a navigation device is activated, nevertheless, it is ensured that upon dropping below a minimum fuel reserve, a reliable possibility is provided to find a suitable gas station according to the actual driving situation, thereby giving the motor vehicle operator the possibility to fill the vehicle fuel tank reliably prior to complete exhaustion of the fuel.

According to a preferred embodiment of the invention, the gas station is selected to be in a direction lying in the general direction of the actual driving direction, and which deviates from the driving direction by less than 45°. Alternatively or supplementally, it has been found desirable to select a path of the road, which is defined by a corridor bracketing the selected road or an extension thereof, wherein the corridor is determined to be in particular less than 10 km from the ascertained road or the extension thereof. Thereby, it has been found particularly advantageous to select this separation, or as the case may be, the deviation, from the direction of driving to be smaller, the greater the minimum fuel reserve is defined to be. If the minimum fuel amount is, for example, twice as large so that therewith twice the range is achieved, then it has been found useful to halve the separation, or as the case may be, the deviation from the direction of driving. This insures a sufficient safety prior to unintended complete expenditure of the fuel reserve with, at the same time, less undesired deviation from the intended driving direction.

Beyond this, it has been found particularly advantageous when the selection of the gas station takes into consideration only those which, in addition to satisfying the criteria depending upon the direction or the path of the ascertained road, in addition are located within a particular predetermined range from the ascertained position of the vehicle. Alternatively thereto it has been found useful, in addition to selection of gas stations based on the direction or path of the road, to additionally apply the criteria of the least distance, so that the closest gas station in the predetermined direction and/or along the path of the ascertained road is selected, or as the case may be, is determined. In the predetermined distance, ranges in the range of 50 to 70 km have been found particularly advantageous. By this preferred embodiment of the invention, a higher operational reliability of the vehicle is provided.

According to a particularly preferred embodiment of this invention, the predetermined distance from the position of the vehicle, within which the gas station is to be found, is supplementally selected depending upon fuel amount and facultatively depending upon fuel consumption. In the case of low remaining fuel amount, the predetermined distance is selected to be smaller, or as the case may be, in the case of higher vehicle fuel consumption, the predetermined distance is in appropriate manner likewise selected to be smaller, or as the case may be, in the reverse in the case of higher fuel amounts or lower fuel consumption, the predetermined distance is selected to be higher. By this adaptation of the predetermined distance within which the gas station can be selected, a yet higher degree of sureness is provided prior to an unintended complete exhaustion of the fuel reserve of the motor vehicle. A very unpleasant, and in certain cases, dangerous inoperability of the motor vehicle on the basis of an empty gas tank can therewith be substantially precluded.

This safety and security can be further increased by a particularly preferred embodiment of the invention in which the predetermined distance is so selected that a fuel reserve remains in the motor vehicle upon reaching the intended gas station. This can be achieved thereby, that in the determination of the predetermined distance, it is not the actual fuel amount that is taken into consideration, rather a reduced amount of remaining fuel, which is less than the minimum fuel amount. By this design, it is ensured that in the case of unforseen situations, for example, in the case that an open and functional gas station is not found at the target location, or as the case may be, at the end of the route guidance, a sufficient residual fuel amount remains available in order to make it possible to travel to a further gas station in the area of the first determined gas station.

Beyond this, it has been found particularly useful to provide an output or display for driving instructions or directions, which are so designed and operated, that as long as no instruction occurs, or deviation from the actual road being traveled or from the actual driving direction, then information regarding the distance to the selected gas station or, in certain cases, the actual fuel amount, is output. By this information, the motor vehicle operator has very reliable information regarding the actual condition of the vehicle with regard to the amount of fuel present, or as the case may be, the distance to the selected gas station at which refueling is possible or, as the case may be, is planned. By the inventive switching between the driving instructions and the distance to the selected gas station or, as the case may be, the fuel amount, it is accomplished that the load on the operator is limited or reduced and that he is provided with the most relevant, or as the case may be, essential information via the output of the device. Unnecessary information is thereby not made available to the driver, so that he is not distracted thereby. Thus, supplementally improves driving safety.

Beyond this, it has been found particularly advantageous to so operate the device, that the navigation device is activated only when the fuel amount drops below the minimum fuel reserve. Thereby, a reduction in the energy consumption of the device for the motor vehicle is achieved, which further increases the operating reliability of the vehicle. Upon falling below of the minimum fuel amount, the navigation device is brought into operation, and subsequently determines the position of the motor vehicle, and from this, the actual direction of driving and in certain cases the road, upon which the vehicle is determined to be located. On the basis of this driving direction or ascertained road information, then a suitable gas station is selected, at which the vehicle operator can preferably fill his fuel reserves. Thereby, it is accomplished with reliable safety to prevent the vehicle from becoming inoperable on the basis of a complete expenditure of the fuel reserve.

In the following, the present invention will be explained on the basis of a preferred embodiment of the inventive device. The invention is not limited to this preferred embodiment.

### BRIEF DESCRIPTION OF THE DRAWINGS

FIG. 1 shows a schematic of an inventive device for a motor vehicle, for the avoidance of an unintended complete exhaustion of the fuel reserve of the motor vehicle.

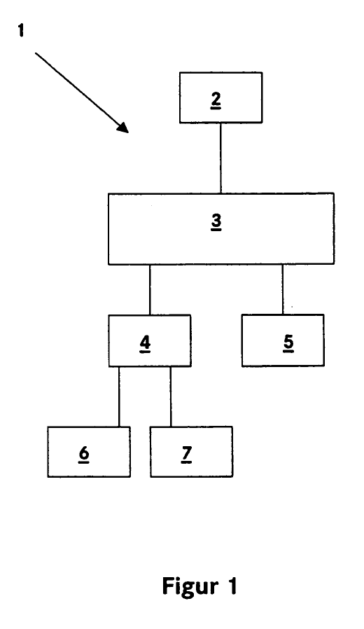

### DETAILED DESCRIPTION OF THE INVENTION

The inventive exemplary device 1 for a motor vehicle for avoidance of an unintended complete exhaustion of the fuel reserves of the vehicle includes a sensor 2 for determining the amount of fuel remaining in the vehicle. The sensor 2 is connected to the control unit 3 of the device 1. The device further includes a navigation device 4, which is adapted to calculate a route of travel from a starting point to a target and to provide to the driver appropriate driving instructions via an output or display unit 5. The output unit 5 is in the form of a display for graphic output of driving instructions, or as the case may be, is an acoustic output for relaying acoustic instructions. The navigation device 4 is equipped with a location unit 6 in the form of a global positioning system 6 and a memory unit 7 for map data.

If the fuel amount falls below a predetermined minimum fuel amount, and if this is detected by the sensor 2, which at regular intervals measures the fuel amount, then the control unit 3 of the navigation device 4 is brought into operation, that is, either completely supplied with electricity or is awakened from a standby condition, so that the navigation device 4 can determine the actual location of the vehicle in association with the location system 6 and the memory 7, and on the basis of the actual position, can determine the actual direction of driving and beyond this additionally the road upon which the vehicle is actually located. On the basis of the actual driving direction and the actual road, then on the basis of the map data stored in the memory 7 a gas station is selected which lies essentially in the determined direction and along the path of the determined road. Therein, there is taken into consideration in particular a corridor bracketing the ascertained actual road or its extension, or as the case may be, within an angle on either side of the determined direction of driving is taken into consideration. After a gas station has been determined or selected on the basis of the above-described selection criteria with use of the map data in the memory 7, a route guidance is activated in the navigation device 4, for which the starting point is the determined position of the vehicle, and the target is selected to be the position of the selected gas station.

Now, on the basis of the activated route guidance, subsequent to the initially not activated navigation system, or as the case may be, the initially not activated route guidance, the driver is provided with the necessary driving instructions for reliable reaching of a suitable gas station. By these driving instructions, which are provided to the vehicle operator both acoustically as well as optically, it is accomplished that an unintended complete consumption of the fuel reserve, and therewith a particularly stressful and dangerous stalling of the motor vehicle in particular on a highway or in a tunnel or the like, is prevented. Therewith, an increase in the traffic safety for the driver and the occupants, as well as for the vehicle and for other traffic participants, is accomplished.

1-7. (canceled)

8. A device for a motor vehicle, for avoiding an unintended complete depletion of the fuel reserves of the motor vehicle, comprising:
a sensor for determining the amount of fuel present in the vehicle,
a navigation device, designed to determine a route to a gas station and to provide appropriate route guidance in the form of driving instructions upon dropping below a minimum fuel amount,
wherein the navigation device is so controlled, that
(a) in the case that the route guidance function is inactive, the position of the vehicle is ascertained, and from this the actual direction of driving and/or the road upon which the vehicle is actually located is ascertained,
(b) a gas station is identified in the direction of driving and/or along the path of the ascertained road, wherein the direction from which the gas station is selected is derived from the ascertained driving direction and wherein the path of the road is derived from the ascertained road, and
(c) the route guidance function is activated, with the determined position as starting point and the identified gas station as goal.

9. The device for a motor vehicle according to claim 8, wherein in the identification of the gas station
a gas station is selected of which the direction deviates from the driving direction by less than 45°,
and/or a path of the road is selected, which is defined by a corridor bracketing the ascertained road or the extension thereof, within which the identified gas station is located, wherein the corridor is determined to have a distance to the road or its extension of less than 10 km.

10. The device for a motor vehicle according to claim 8, wherein a gas station is selected further satisfying the criteria that it is located within a predetermined distance from the position of the vehicle, or further satisfying the criteria that it is the nearest located gas station.

11. The device for a motor vehicle according to claim 10, wherein the distance of the predetermined distance is selected depending upon the amount of fuel remaining.

12. The device for a motor vehicle according to claim 11, wherein the predetermined distance is selected depending upon the fuel remaining and fuel consumption, so that a residual fuel amount remains available in the motor vehicle upon the planned reaching of the gas station.

13. The device for a motor vehicle according to claim 8, wherein an output is provided, by means of which the distance to the selected gas station or the fuel amount remaining is provided to the vehicle operator, as long as no instruction is needed or given for deviation from the actual driven road or the actual driving direction.

14. The device for a motor vehicle according to claim 8, wherein the navigation system is brought into operation only when the fuel amount drops below a minimum fuel amount.
